(19) United States
(12) Patent Application Publication
(10) Pub. No.: US 2010/0170037 A1
(43) Pub. Date: Jul. 8, 2010

(54) LIFTING AND LOWERING CUSHION

(76) Inventors: Richard Fletcher, Leominster (GB); Richard Rimington, Presteigne (GB); Chris Bolger, Presteigne (GB)

Correspondence Address: CHERNOFF, VILHAUER, MCCLUNG & STENZEL, LLP, 601 SW Second Avenue, Suite 1600, PORTLAND, OR, 97204-3157, US

(21) Appl. No.: 12/451,458

(22) PCT Filed: Jun. 4, 2008
(86) PCT No.: PCT/GB2008/001901

§ 371 Date: Mar. 26, 2010

(30) Foreign Application Priority Data
Jun. 4, 2007 (GB) 0710626.3

(51) Int. Cl. A61G 7/10

(52) U.S. Cl. 5/83.1

(57) ABSTRACT

A device for lifting and lowering a person in a confined space which comprises an inflatable cushion with a seating surface and an inflatable back rest attached thereto. The back rest is movable relative to the cushion and attached so that when the device is inflated the back rest is biased into an open position such that it extends in substantially the same plane as the seating surface of the cushion. The device is also provided with at least one aperture located between the back rest and the cushion.

This invention relates to apparatus for lifting and/or lowering persons in confined spaces. More specifically the invention relates to apparatus for lifting and lowering persons in a bath tub.

Various forms of apparatus are known for assisting persons into and out of bath tubs. For example, it is known to use hoists to lift and lower persons in a recumbent or sitting posture. These devices however are cumbersome and awkward to use in a confined space as often found in bathrooms. The applicant has invented a device for lifting and lowering persons in confined spaces which is disclosed in PCT publication No. WO/01/91690 and UK publication No. GB2358797. The device disclosed in these applications comprises an inflatable structure with a seating surface and an inflatable back support attached thereto. The device requires a rigid plate attached to its underside to ensure the stability of the inflatable structure. When the device is deflated it can be felt by the user and can be uncomfortable. Further said rigid plate makes the device awkward to fold and store. The device also has a pinched waist between the seat and back support to produce a hinge between these two elements. The waist results in a sharply concave section of the periphery weld at this point. Such a concave weld experiences enhanced stresses when the product is pressurised.

An object of the present invention is to provide a lifting and lowering device for use in confined spaces which overcomes, or obviates the problems associated with the known devices.

A further object of the invention is to provide a stable lifting and lowering device which can withstand high internal pressures.

Yet a further object of the invention is to provide a lifting and lowering device which is compactable, lightweight and easy to carry and stow.

According to the invention there is provided a device for lifting and lowering a person in a confined space, comprising an inflatable cushion with a seating surface and an inflatable back rest attached thereto and movable relative to the cushion, said back rest attached so that when the device is inflated the back rest is biased in an open position such that it extends in substantially the same plane as the seating surface of the cushion and wherein said device is provided with at least one aperture located between the back rest and cushion.

The device can thus be placed in a confined space such as a bath tub and inflated to provide a raised seating surface for the user to sit upon. When the device is inflated the back rest is biased in an open extended position. By deflating the device the person is lowered to the bottom of the bath. At the same time the back rest also deflates but since it is biased in the open position it comes into contact with the sloping back wall of the bath tub and is pushed towards an upright position relative to the seating surface. Since the back rest is biased to the open position the back rest comes into intimate contact with the back slope of the bath and conforms to the angle of the bath slope. This enhances the stability both of the device and the user; it provides a comfortable back support for the bather assisting the bather to sit in a sitting posture in the bath.

Preferably, the back rest is attached to the cushion by hinge means.

The device may be provided with at least one locating element on a lower part of the cushion to enable the device to be positioned correctly in the bath with respect to the back slope of a bath. As the device is deflated in the bath the back rest is forced into contact with the back slope of the bath. Preferably, the at least one locating element is handle shaped.

The at least one aperture is preferably located centrally along the hinge line between the cushion and the back rest. When the device is deflated the device is folded such that the aperture receives the at least one locating element to provide a handle for carrying and storing the device.

More preferably the hinge means is biased towards an open position. The cushion may comprise a plurality of air bags stacked one on top of each other. Preferably the back rest is attached to the uppermost bag.

Preferably still the device is provided with support means for engaging with a support surface upon which the device is placed. More preferably the support means comprises suction cups. More preferably still, the device comprises four suction cups.

The invention will now be described, by way of example only, with reference to the following drawings in which:

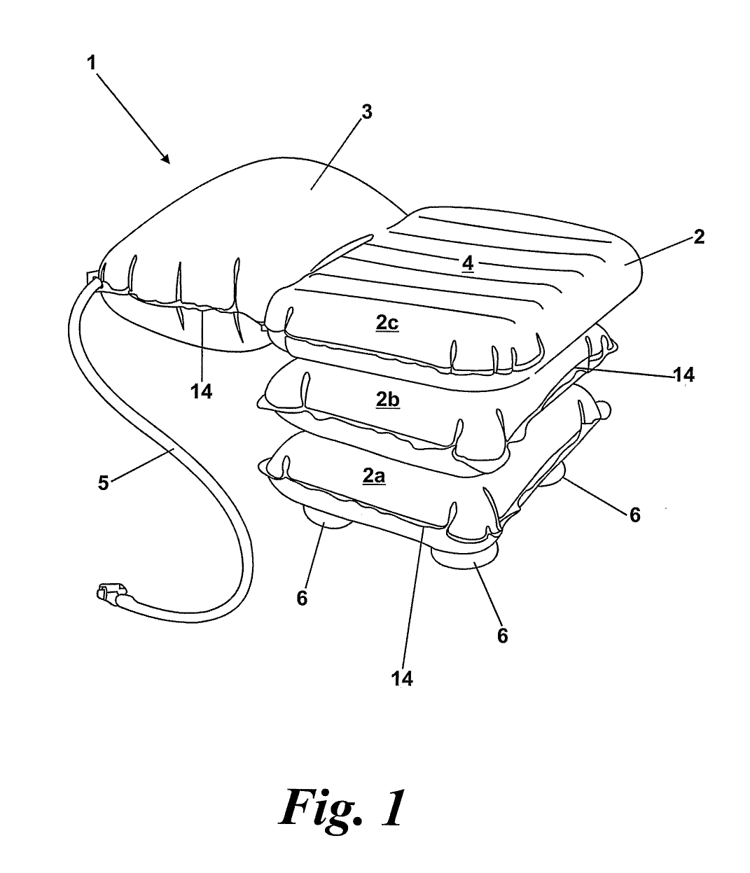

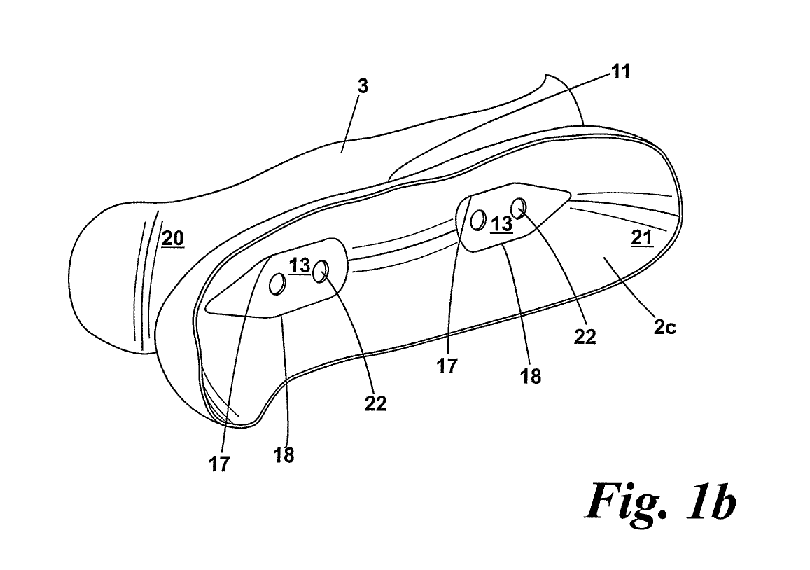

FIG. 1 is a perspective view of the inflated device according to the invention,

FIG. 1b shows a perspective view of an inside part of the inflated device according to one aspect of the invention,

FIG. 1c is a plan view of FIG. 1b,

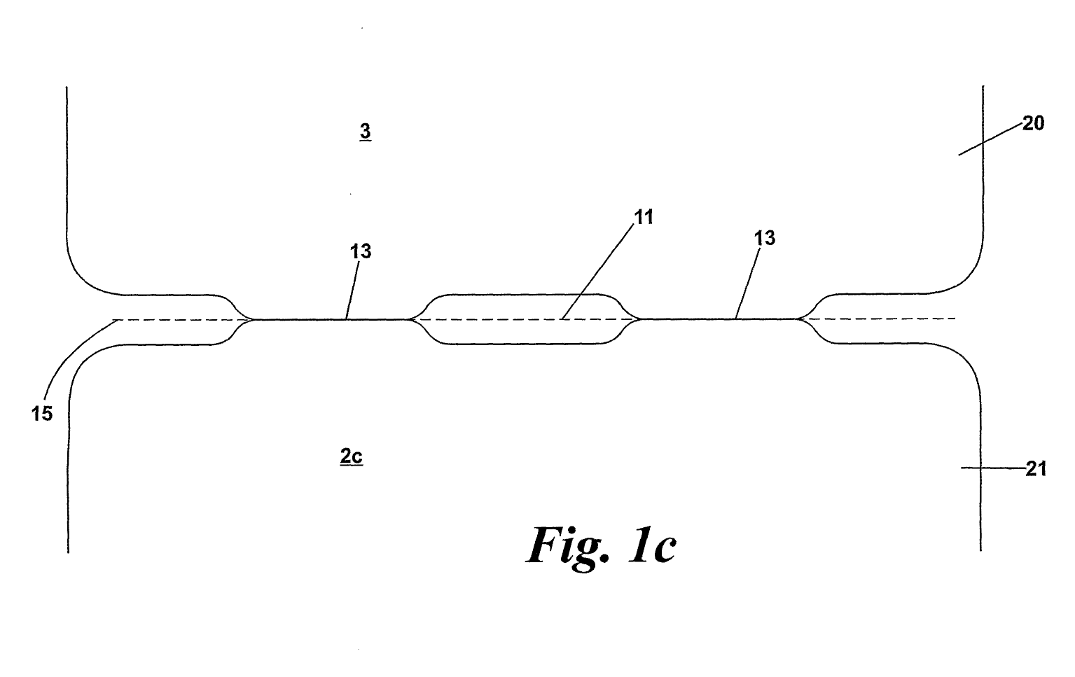

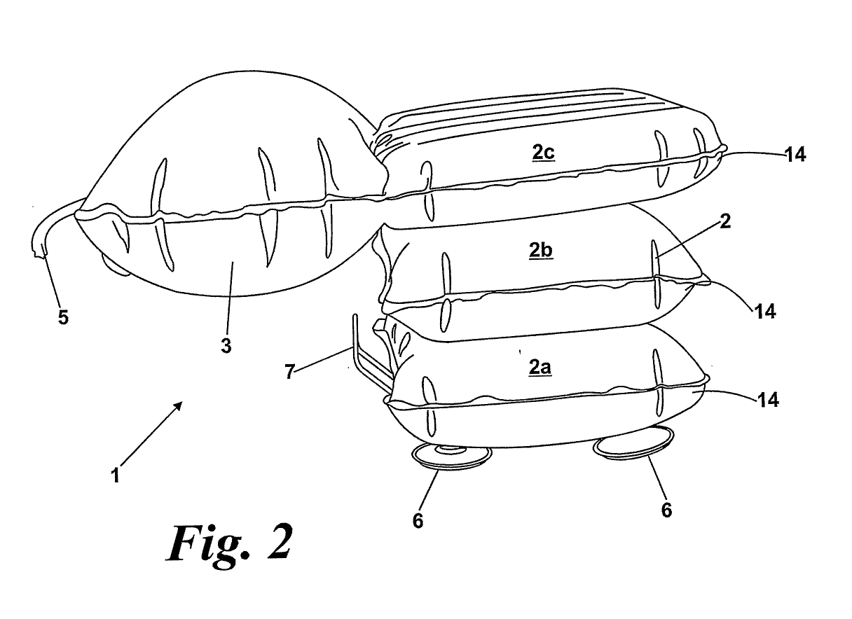

FIG. 2 is a side view of the device of FIG. 1 fully inflated, and

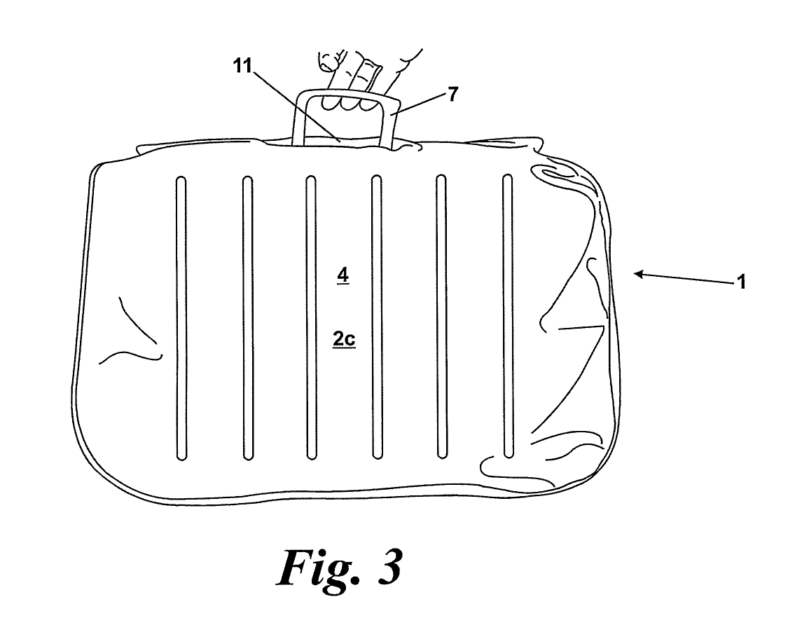

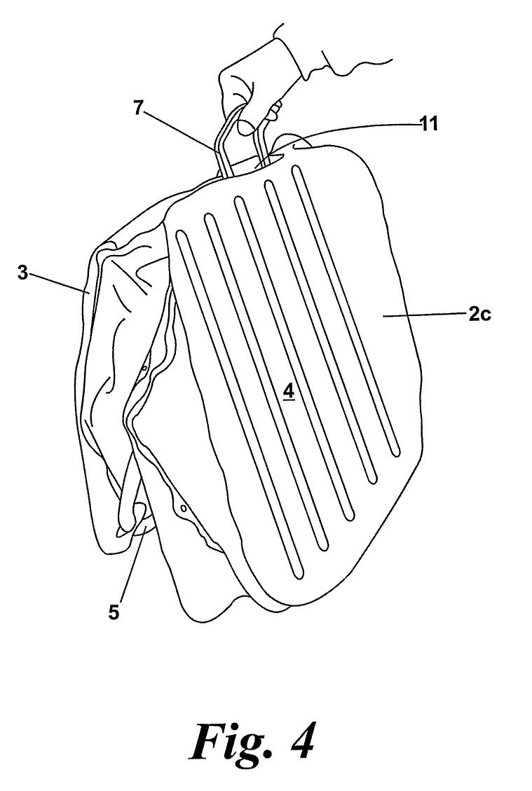

FIGS. 3 and 4 show the device of FIG. 1 in a deflated folded state.

FIG. 1 shows a lifting and lowering device 1 comprising an inflatable lifting cushion 2 and an inflatable back rest 3. The cushion has a ridged upper surface which provides a seating surface 4 upon which a person may sit. The cushion 2 comprises a stack of three inflatable bags 2a, 2b and 2c of a rectangular shape. The back rest 3 comprises a single, inflatable panel which is the same width as the cushion and is attached to the uppermost bag 2c. In FIG. 1 the bags 2a and 2b are each formed from two pieces of fabric, such as a plastics material which are welded together along a seam line 14 which extends around the mid height of each of the inflated bags. Bag 2c and the back rest 3 are constructed so that one side of the bag or panel is seam free. (The construction of the back rest 3 and bag 2c is described later on with reference to FIG. 1b).

Bags 2a, 2b and 2c are provided with internal webs which are attached to the internal surfaces of each of the bags to control their shape and form when inflated. The back rest 3 when inflated has convex sides. The bags 2a, 2b and 2c and back rest 3 are connected so that the fluid, for example gas which is used to inflate the device 1 can flow freely between all parts of the device. The back rest 3 is provided with an input/output to which a gas supply line 5 is fitted. The gas supply which is not shown may be provided by a pump and may be controlled by a hand control (not shown). The back rest is connected to the cushion 2 such that it is biased to the open position when the device is inflated as shown in FIG. 1. By open position it is meant that the back rest 3 extends in substantially the same plane as the surface of the seat 4. The lower most bag 2a is provided with four supports 6 having broad feet for contact with the support surface, such as the ground, or bath upon which the device is to be used. The supports 6 may comprise suction cups which prevent movement of the device 1 on the support surface. The back rest 3 may be connected to the cushion 2 by a stiff hinge means biased to the open position. A central aperture (not shown) is provided between the back rest 3 and the cushion 2 along the line of attachment. If a hinge means is provided, a central aperture is provided along the hinge line between the back rest 3 and cushion 2. The aperture receives a locating element (not shown) when the device is deflated which is described later.

To use the device 1, the device is fully inflated on a support surface which may be a surface in a confined space, for example a bath tub. A locating element which is described later ensures that the device is correctly positioned within the bath with respect to the back slope of the bath. A bather can then sit on the device and as the device is deflated the person will be lowered into the bath tub in a sitting posture. Since the back rest 3 is biased in the open position it comes into contact with the sloping back wall of the bath tub as the device 1 is lowered. The back rest 3 is therefore pushed towards an upright position relative to plane of the seating surface 4 and the back rest comes into intimate contact with the back slope of the bath and conforms to the angle of the bath slope. This enhances the stability of the device 1 and provides pelvic stability and a comfortable back support for the bather allowing the bather to sit in a sitting posture in the bath. The back rest 3 may be deflated to allow the bather to lie against the back slope of the bath or only be partially deflated so that the bather has a cushion between the slope of the bath and his or her back. When the bather has finished bathing, the device 1 can simply be inflated which raises the person in a sitting posture and allows the bather to simply stand up from the device 1 and move out of the bath.

FIG. 1b shows an internal perspective view of the connection of the uppermost bag 2c to the back rest 3. FIG. 1c is a plan view of the connection of the uppermost bag 2c to the back rest 3. Bag 2c and back rest 3 are connected by two weld areas 13. The weld areas connect the rear face of the bag 2c to the front face of the back rest 3. A central portion is left unwelded forming an aperture 11. The weld areas form a line of attachment, or hinge line 15 of reduced inflated height between the back rest 3 and bag 2c. The hinge line 15 results in a line of reduced bending strength in the inflated device therefore forming a line about which the back rest 3 will pivot relative to the bag 2c. This method of construction allows passage of a locating element (not shown) through the aperture 11 in the hinge line when the device is deflated yet maintains the stiffness of the connection between the bag 2c and back rest 3 when the device is inflated. The weld areas 13 each contain two through ports 22 to permit fluid connectivity between the bag 2c and the back rest 3. The device may contain a greater or fewer number of through ports than those shown in FIG. 1b. It is also possible to introduce valve means within the ports 22 joining the back rest 3 to the bag 2c. This way the back rest 3 can sit the bather up before inflating the cushion 2 of the device 1. Each of the weld areas 13 have an upper edge 17 and a lower edge 18. The further apart these edges are the greater the distance between the edges and the greater the degree of stiffness of the hinge. The weld areas 13 can therefore be optimised for the correct functioning of the device 1.

Rigid plates may be located on the interior of the back rest 3 and/or bag 2c to reinforce the stiffness of the weld areas 13.

In FIG. 1b, the back rest 3 and cushion 2 are constructed in an alternative way to that described in FIG. 1. The bag 2c and back rest 3 are made from three fabric panels, for example plastic panels. Two short panels 20 and 21 as shown in FIG. 1b make up the hinge connection between the bag 2c and the back rest 3. A third panel (not shown) is connected to panel 21 at the underside rear edge and is wrapped so that it forms the seating surface 4. It is then welded to the upper edges of the weld areas 13 between panels 20 and 21 and further extended to for the remainder of the covering of the back rest 3 and secured to panel 20 at the underside front edge of the back rest 3.

FIG. 2 shows a side view of the device 1. A locating element 7 is shown attached to the lowest bag 2a. The locating element 7 is semi-rigid and made of a hard wearing material, such as a metallic or, plastics material. The element 7 has the for of a handle. The locating element is located in a central position on the rear of the bag 2a of the device 1. The element 7 has two functions. One, it ensures the device 1 is positioned in the bath correctly by spacing it from the slope of the bath. This ensures that the back rest interacts with back slope of the bath in the desired manner. The second function is that it provides a handle to carry the device, or hang it up for storage, when the device is deflated and folded as shown in FIGS. 3 and 4.

When the device 1 has been used and is ready to be stored it may be deflated as shown in FIGS. 3 and 4 into a more compact form.

FIGS. 3 and 4 show the device 1 in a deflated state ready to be carried or stowed. The locating element 7 is inserted through the aperture 11 between the back rest 3 and seating surface 4 and the back rest 3 is then folded over the three air bags 2a, 2b and 2c so that it comes into contact with the supports 6. The deflated device 1 can then be carried conveniently by the locating element 7. The locating element 7 also provides a means for hanging the device 1 in storage.

The device is compactable, lightweight and easy to carry and quick to use. Further it may be used without requiring carers or other persons to assist the bather.

It is understood that the scope of the present invention is not limited by the embodiment shown in the drawings. In particular the device may be made in a wide range of sizes to suit different uses. Moreover, the invention includes any novel and inventive feature disclosed herein either alone or in combination with any one or more other such features.

1. A device for lifting and lowering a person in a confined space such as a bath comprising an inflatable cushion with a seating surface and an inflatable back rest attached thereto and movable relative to the cushion, said back rest attached so that when the device is inflated the back rest is biased in an open position such that it extends in substantially the same plane as the seating surface of the cushion, wherein said cushion and said back rest are attached by a hinge means defined by spaced attachment areas between a rear face of the cushion and a front face of the back rest, a central portion between the attachment areas being un-connected to provide an aperture between the back rest and cushion.

2. The device as claimed in claim 1 wherein the rear face of the cushion and the front face of the back rest are welded together in the attachment areas.

3. The device as claimed in claim 1 wherein the device is provided with at least one locating element on a lower part of the cushion, for locating the device relative to a surface of the confined space.

4. The device as claimed in claim 3 wherein the device is for use in a bath having a back slope, and wherein the at least one locating element is configured to assist with the positioning of the device relative to the back slope of the bath.

5. The device as claimed in claim 3 or claim 4 wherein the at least one locating element is handle shaped.

6. The device as claimed in claim 3 wherein when the device is deflated and folded the at least one aperture receives the at least one locating element to provide an accessible handle for carrying and storing the device.

7. The device as claimed in claim 1 wherein the back rest is provided with an input/output for connection to a gas supply.

8. The device as claimed in claim 1 wherein the back rest and cushion are connected so that fluid can flow freely therebetween.

9. The device as claimed in claim 8 wherein at least one port is provided between the back rest and cushion.

10. The device as claimed in claim 9 wherein the at least one port is provided with valve means.

11. The device as claimed in claim 9 or claim 10, in which the, or each, port is located in one of the attachment areas.

12. The device as claimed in claim 2, in which rigid plates are located in the interior of at least one of the back rest and the cushion to reinforce the stiffness of the weld areas.

13. The device as claimed in claim 1 wherein the cushion comprises a plurality of air bags stacked one on top of each other.

14. The device as claimed in claim 13 wherein the bags are connected so that fluid can flow freely therebetween.

15. The device as claimed in claim 13 wherein the back rest is attached to the uppermost bag.

16. The device as claimed in claim 1 wherein the device is provided with support means for engaging with a support surface upon which the device is placed.

17. The device as claimed in claim 16 wherein the support means comprises suction cups.

18. (canceled)
